(19) United States
(12) Patent Application Publication
(10) Pub. No.: US 2011/0131178 A1
(43) Pub. Date: Jun. 2, 2011

(54) MANAGING DATA IN MARKUP LANGUAGE DOCUMENTS STORED IN A DATABASE SYSTEM

(75) Inventor: NICHOLAS KANELLOS, Ottawa (CA)

(73) Assignee: INTERNATIONAL BUSINESS MACHINES CORPORATION, Armonk, NY (US)

(21) Appl. No.: 12/629,653

(22) Filed: Dec. 2, 2009

(51) Int. Cl. G06F 17/30

(52) U.S. Cl. 707/609; 707/E17.005

(57) ABSTRACT

Methods and systems are disclosed for storing, propagating, and searching for data stored in markup language documents, such as a data hierarchy defined by an XML schema. Each node in the data hierarchy may include an XML document representing an instance of the thing being categorized at that level of the hierarchy. A collection of such documents may be stored in a relational database according to a schema for storing the XML documents as well as the parent child relationships between the documents, i.e., a schema describing the data hierarchy. Further, a document at one node in the hierarchy may inherit attributes from its ancestors. That is, one node within a given hierarchy may inherit data from other nodes in the hierarchy as well as propagate information to descendants.

### BACKGROUND OF THE INVENTION

1. Field of the Invention

Embodiments of the invention generally relate to managing data. More specifically, embodiments of the invention relate to techniques for storing, propagating, and searching for data stored in XML documents that are organized in a taxonomy or hierarchy and stored in a database system, such as a relational database.

2. Description of the Related Art

The practice of organizing information into taxonomies or hierarchies of nodes is widespread. For example, organizational charts arrange people or departments into hierarchies; catalogs arrange products into hierarchies of product types or product categories; and records management systems arrange documents and records into hierarchies of dossiers or files based on subject areas. Of course these represent just a few examples of organizing data into a hierarchy.

Data describing these (and other) types of information (e.g., documents, products, personnel, departments, etc) may be stored in nodes of a markup language document organized according to the structure of a given hierarchy. For example, hierarchical information may be stored in elements of an XML document composed according to a schema representing a given hierarchy. Further, commercial database management systems (e.g., DB2, Oracle, SQL Server) provide the capability to store data in native XML format as columns in database tables. As a result, storing data having an XML format in relational database systems has become common practice. Once so stored, business applications may provide features based on the hierarchical arrangement of items and the attachment of data to those items. This data may also be in an XML format. That is, application programs may query nodes of the hierarchy to retrieve the data elements stored by a particular node. Such a query may identify a node directly (e.g., a query identifying a node by a unique product ID) or using conditions (e.g., a query requesting a list of nodes (or product IDs) having a specified set of attributes).

### SUMMARY OF THE INVENTION

One embodiment of the present invention includes a computer-implemented method for managing data stored in a hierarchy having a plurality of nodes. The method may generally include configuring one or more computer processors to perform an operation. The operation itself may generally include identifying a first node of the hierarchy. Each node of the hierarchy of nodes may be configured to store values for a set of one or more attributes or markup language documents. The operation may further include identifying, for the first node, one of the attributes for which a value is not stored by the first node, and also include traversing, from the first node, to an ancestor node of the first node. The ancestor node stores a value for the first attribute not stored by the first node. The operation may also include inheriting, by the first node, the value for the first attribute stored by the ancestor node.

Another embodiment of the invention includes a computer-readable storage medium containing a program which, when executed by a processor, performs an operation for managing data stored in a hierarchy having a plurality of nodes. The operation itself may generally include identifying a first node of the hierarchy. Each node of the hierarchy of nodes may be configured to store values for a set of one or more attributes or markup language documents. The operation may further include identifying, for the first node, one of the attributes for which a value is not stored by the first node, and also include traversing, from the first node, to an ancestor node of the first node. The ancestor node stores a value for the first attribute not stored by the first node. The operation may also include inheriting, by the first node, the value for the first attribute stored by the ancestor node.

Still another embodiment of the invention includes a system having one or more computer processors and a memory containing a program, which when executed by the one or more computer processors is configured to perform an operation for managing data stored in a hierarchy having a plurality of nodes. The operation itself may generally include identifying a first node of the hierarchy. Each node of the hierarchy of nodes may be configured to store values for a set of one or more attributes or markup language documents. The operation may further include identifying, for the first node, one of the attributes for which a value is not stored by the first node, and also include traversing, from the first node, to an ancestor node of the first node. The ancestor node stores a value for the first attribute not stored by the first node. The operation may also include inheriting, by the first node, the value for the first attribute stored by the ancestor node.

Yet another embodiment of the invention includes a method for managing data stored in a hierarchy having a plurality of nodes. This method may include configuring one or more computer processors to perform an operation. And the operation itself may generally include identifying a first node of the hierarchy, where each node of the hierarchy of nodes is configured to store values for a set of one or more attributes. Additionally, the first node may store a value for at least a first attribute of the set of one or more attributes. The operation may also include propagating, from the first node, the value for at least the first attribute to one or more descendant nodes.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a computing infrastructure configured for managing data stored in XML documents that are organized in a taxonomy or hierarchy in a database system, according to one embodiment of the invention.

FIG. 2 is a more detailed view of the server computing system of FIG. 1, according to one embodiment of the invention.

FIG. 3 is a more detailed view of the client system of FIG. 1, according to one embodiment of the invention.

FIG. 4 illustrates an example of a hierarchy of data stored in an XML document, according to one embodiment of the invention.

FIG. 5 illustrates an example of a relational database schema and data tables used to store a hierarchy of data stored in an XML document, according to one embodiment of the invention.

FIG. 6 illustrates a method for storing data organized in a taxonomy or hierarchy in a database system, according to one embodiment of the invention.

FIG. 7 illustrates a method for inheriting values for a data record stored in a taxonomy or hierarchy in a database system, according to one embodiment of the invention.

FIG. 8 illustrates a method for retrieving data records stored in a taxonomy or hierarchy in a database system, according to one embodiment of the invention.

FIGS. 9A-9B provide an example of a hierarchy used to further illustrate the method shown in FIG. 8, according to one embodiment of the invention.

### DETAILED DESCRIPTION

Embodiments of the invention provide techniques for storing, propagating, and searching for data stored in markup language documents. The markup language documents may organize data in a taxonomy or hierarchy. Each node in the hierarchy may include a document representing an instance of the thing being categorized at that level of the hierarchy. A collection of such documents may be stored in a relational database. More specifically, embodiments of the invention provide techniques for one node within a given hierarchy to inherit data in from other nodes stored in the hierarchy, typically ancestral nodes. Conversely, embodiments of the invention provide techniques for one node to propagate information from that node to descendant nodes.

In one embodiment, data from a node in the hierarchy may implicitly inherit data from ancestor nodes. If a node lacks an explicit definition for a given element, then the hierarchy may be traversed upward from that node until an explicit definition is found. Using this approach, any node within a hierarchy may implicitly inherit all the data attached to the nodes in the hierarchy above it. Thus, embodiments of the invention provide the ability to accumulate the inherited data at any node and enable searching for nodes based on data values that are inherited, in addition to searching based on data values assigned to a given node.

In another embodiment, data from a node in the hierarchy may be inherited via a mechanism employing references. For example, each node in a hierarchy may expressly refer to an XML document assigned to it or one of its ancestors from which the node inherits data values. This approach may allow a node to determine an inherited value directly without having to traverse any intermediate nodes in the hierarchy. Similarly, in one embodiment, when a node is assigned a “seed” value (i.e., a value for an element which nodes below it inherit), that value may be propagated to each descendant node. Depending on the relative frequencies of data updates, data reads, and other factors, either approach may be preferred in a particular case.

Further, in each of these approaches for data inheritance, nodes below a “seed” node may override an inherited value with an expressly assigned one. Thus becoming seeds themselves to their descendent nodes.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Further, a particular embodiment of the invention is described using a collection of software applications including a query tool, a data inheritance tool, and a database management system (DBMS) used to store a hierarchy of XML documents representing a product catalog. The product catalog provides a particular example of a hierarchy where nodes of the hierarchy inherit data in from other nodes stored in the hierarchy. However, it should be understood that the invention may be adapted for a broad variety scenarios where data may be arranged in a hierarchy, and further that XML is used as a representative example of a markup language used to describe elements of nodes within a hierarchy. Of course, other markup languages and data storage mechanisms may be used without departing from the scope of the present invention. Accordingly, references to this particular embodiment are included to be merely illustrative and not limiting.

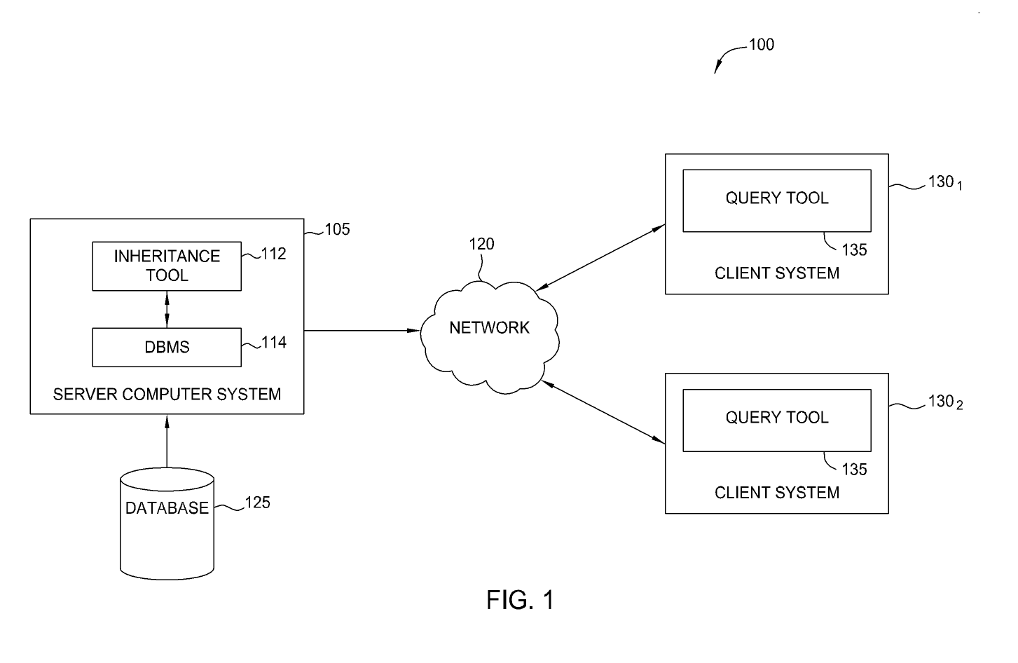

FIG. 1 illustrates a computing infrastructure 100 configured for managing data stored in XML documents that are organized in a taxonomy or hierarchy in a database system 125, according to one embodiment of the invention. As shown, the computing infrastructure 100 includes a server computer system 105 and a plurality of client systems 130₁₋₂, each connected to a communications network 120.

In one embodiment, a query tool 135 on each client system 130₁₋₂ communicates over the network 120 to interact with a data inheritance tool 112 and DBMS 112 on the server computer system 105. The database 125 may store a hierarchy of documents representing a full range of products produced or offered by a given entity. In such a case, the database 125 may store a hierarchy of nodes, where the nodes represent different product categories, attributes of categories, or represent one of the products themselves. Further, each node may store one or more XML document with values for some of the elements and/or attributes assigned to the product (or category) represented by that node. Note, a node is not limited to one and only one XML document. That is, one or more XML documents may be attached to a node. In such cases, each document (and the attributes/values contained therein) will be inherited downward separately—as though it were the only document attached to the node. Similarly, documents may be attached at points lower in the hierarchy and achieve the same type of ‘accumulation’ of XML documents in a manner similar to the accumulation of individual attributes.

In one embodiment, when a node is requested (or evaluated as part of search conditions) values not expressly assigned to that node may be inherited from nodes at higher levels of the hierarchy. For example, when the query tool 135 submits a request for all the information related to a given product, the data inheritance tool 112 may be configured to construct a virtual XML document by identifying the particular node in the hierarchy representing the given product, and then traversing up through the hierarchy of documents stored in the database 125 to identity the inherited values. The inheritance tool 112 may then generate the virtual XML document by accumulating all the values inherited while traversing through the hierarchy in the virtual XML document and return the document so generated in response to the request. Similarly, when the query tool 135 is used to query for a product (or category) having certain attributes, the inheritance tool 112 may identify nodes having one of the requested attributes and propagate the values from the identified nodes down though the hierarchy to others. That is, nodes below a “seed” node may inherit values from the “seed” node.

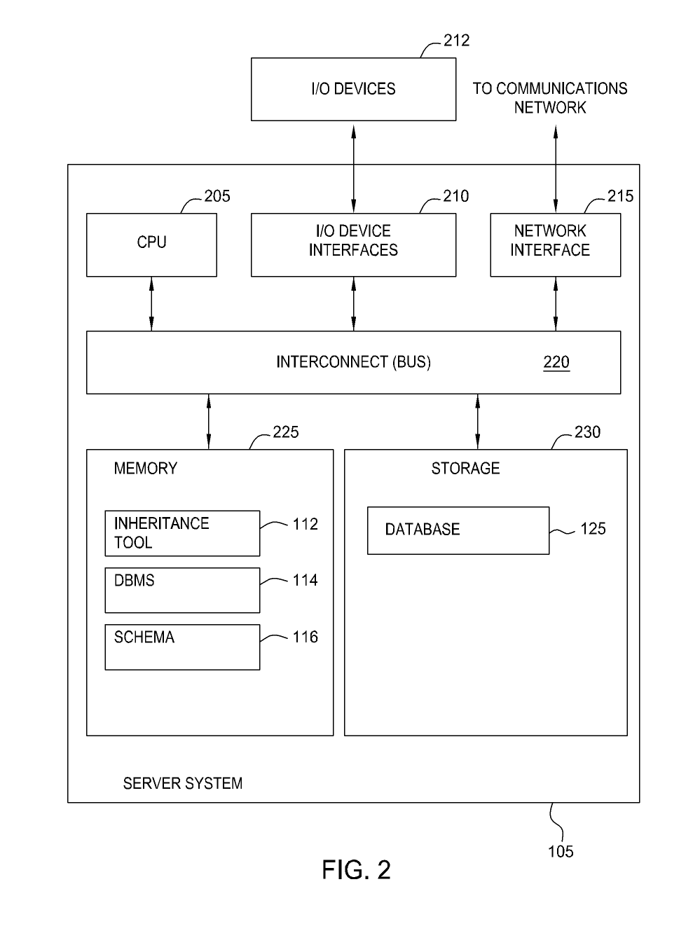

FIG. 2 is a more detailed view of the computing system 105 of FIG. 1, according to one embodiment of the invention. As shown, the server computing system 105 includes, without limitation, a central processing unit (CPU) 205, a network interface 215, an interconnect 220, a memory 225, and storage 230. The computing system 105 may also include an I/O devices interface 210 connecting I/O devices 212 (e.g., keyboard, display and mouse devices) to the computing system 105.

The CPU 205 retrieves and executes programming instructions stored in the memory 225. Similarly, the CPU 205 stores and retrieves application data residing in the memory 225. The interconnect 220 facilitates transmission of programming instructions and application data between the CPU 205, I/O devices interface 210, storage 230, network interface 215, and memory 225. CPU 205 is included to be representative of a single CPU, multiple CPUs, a single CPU having multiple processing cores, and the like. And the memory 225 is generally included to be representative of a random access memory. The storage 230 may be a disk drive storage device. Although shown as a single unit, the storage 230 may be a combination of fixed and/or removable storage devices, such as fixed disc drives, floppy disc drives, tape drives, removable memory cards, optical storage, network attached storage (NAS), or a storage area-network (SAN).

Illustratively, the memory 225 includes the inheritance tool 112, DBMS 114, and a database schema 116, and storage 230 includes the database 125. As noted above, the data inheritance tool 112 may be configured to identify nodes in a hierarchy of documents, where data values at a given node may be inherited from ancestral nodes, as well as propagate values from one node to descendant nodes.

In one embodiment, the nodes themselves may each be represented using an XML document stored within a table of the database 125. Further, the database 125 may store the XML document representation of each node according to schema 116. Generally, the schema 116 may specify a structure for the hierarchy of nodes. For example, the schema 116 may specify that database 125 should store the content of each XML document in one record of a database table and an indication of each parent node and each child node of a given node within records of another table in the database 125. In such a case, the inheritance tool 112 may generate a query passed to the DBMS to retrieve both a requested node, and any ancestral nodes identified through the parent/child relationships stored in the database 125. Further, the requested node may inherit values form the parents of the requested node (and the parents from the parents of the requested node, etc.). Thus, any one node of the hierarchy, while having a full compliment of data, may actually have no data or only a partial set of the data stored directly in the XML document representation of that node.

The process for propagating data down the hierarchy is similar. Starting from a root node, nodes of the hierarchy (i.e., the XML document representation of each node) are evaluated until a node having an express value for a specified element is identified. Once identified, that value may be propagated to each child of that node (and to child nodes of the child node, etc.).

This results in a hierarchy where the actual data values (and thus storage and update requirements) are sparse. That is, the actual node data is stored only at the nodes where a given element is expressly set, regardless of the number of attributes/elements defined for the XML document representing a node. Thus, setting or updating a value at one node, in effect, sets or updates the same data at every descendent node.

Additionally, in one embodiment, the inheritance tool 112 derives the values for a given node using the inheritance mechanisms described above only when the given node is requested (or needs to be evaluated as part of a search). That is, the data values for a node are only inherited when that node is needed for some purpose. Alternatively, however, data values may be inherited whenever a node is added to the hierarchy—and descendants of a given node updated whenever a value in a node is changed. For example, assume a node representing a new product is added to the hierarchy, and that the XML document representing this node includes some, but not all of the values defined for products stored in the product hierarchy. In such a case, the inheritance tool 112 may evaluate the ancestors of the new node to derive a complete product speciation for the new product. Alternatively, the data inheritance tool 112 may include links from the new node to ancestor nodes from which a given data element is inherited. The approach taken need not be exclusively one or the other and may be tailored to suit the needs of a particular case. For example, for largely static hierarchies (i.e., a hierarchy that changes infrequently) fully populating each node may be preferred as searches may be performed more quickly. On the other hand, when values in the hierarchy are expected to change more frequently, data values may be inherited only when needed.

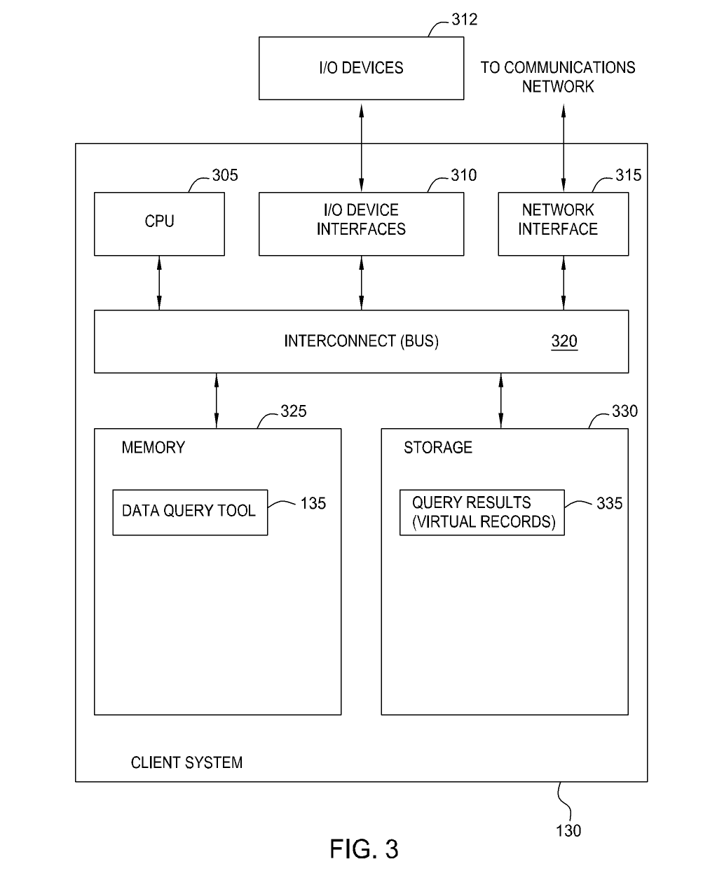

FIG. 3 is a more detailed view of the client system 130 of FIG. 1, according to one embodiment of the invention. As shown, client system 130 includes, without limitation, a central processing unit (CPU) 305, a network interface 315, an interconnect 320, a memory 325, and a storage 330. The client system 130 may also include an I/O devices interface 310 connecting I/O devices 312 (e.g., keyboard, display and mouse devices) to the client system 130.

Like CPU 205 of FIG. 3, CPU 305 is configured to retrieve and execute programming instructions stored in the memory 325 and storage 330. Similarly, the CPU 305 is configured to store and retrieve application data residing in the memory 325 and storage 330. The interconnect 320 is configured to facilitate data transmission, such as programming instructions and application data, between the CPU 305, I/O devices interface 310, storage unit 330, network interface 305, and memory 325. Like CPU 205, CPU 305 is included to be representative of a single CPU, multiple CPUs, a single CPU having multiple processing cores, and the like. Memory 325 is generally included to be representative of a random access memory. Storage 330, such as a hard disk drive or flash memory storage drive, may store non-volatile data. The network interface 315 is configured to transmit data via the communications network 120.

As shown, the memory 325 stores programming instructions and data, including the data query tool 135. As noted above, the data query tool 135 may communicate with the query inheritance tool 112 to get and set data from nodes of the hierarchy. Also as shown, storage 335 includes a set of query results 335. In one embodiment, the query results 335 include virtual XML documents not actually stored in the database, but instead generated by the inheritance tool 112 using the inheritance mechanisms described above. Using the example of a hierarchy of nodes representing a full range of products produced or offered by a given entity, the query tool 135 might be used to retrieve the appropriate product description for a specified product to include in a product manual (stored as query results 335). In such a case, the query tool 135 could be used to insert data for a variety of related products into a template of the manual. As another example, the query tool 135 could retrieve product descriptions of components used in multiple products. For example, data describing a power supply for a consumer electronics device and stored in an XML document (at one node of the hierarchy) could be inherited by each descendant node, as needed. In such a case, the query tool 135 could be used to retrieve a complete list of products that include the power supply, despite the fact that the XML documents representing each such product do not include any data elements describing the power supply. Instead, this information is propagated from the node containing the power supply description to each descendant thereof, resulting in virtual XML documents returned as query results 335.

As yet another example, assume a hierarchy defined to represent data related to the organizational structure of a business. In such a case, the query tool 135 could be configured (among other things) to identify a supervisor of a given department (from a node representing a department level of the hierarchy) and each descendant could inherit the identity of that individual as s supervisor. Should a new supervisor be assigned to the department, each descendent node would then inherit the new value automatically. Of course these scenarios represent only particularized examples, and query tool 135 may be configured to set and retrieve data using a hierarchy tailored for the needs of specific case.

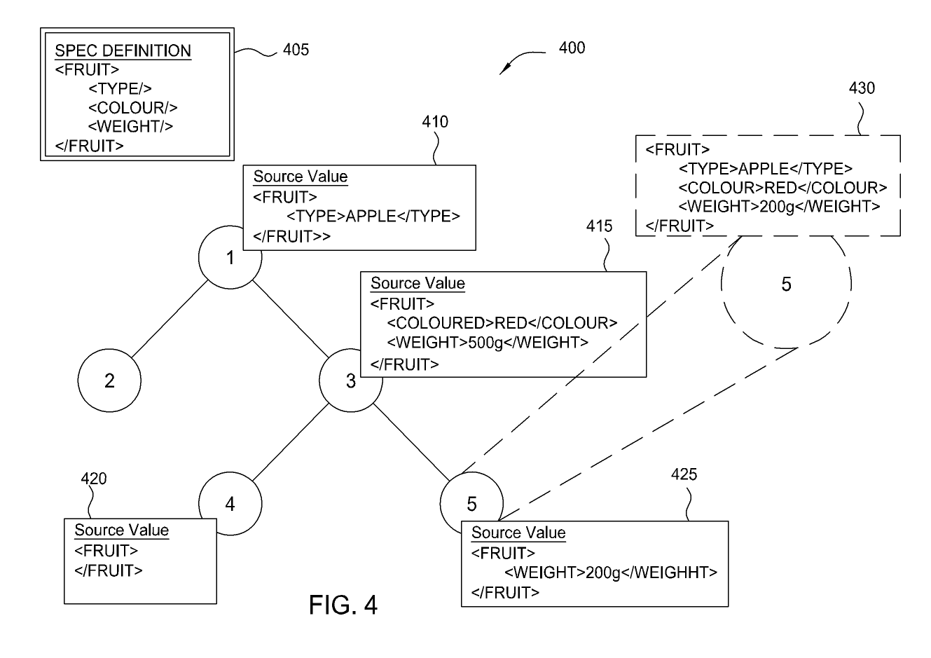

FIG. 4 illustrates an example of a data hierarchy 400 represented using XML documents, according to one embodiment of the invention. Illustratively, an XML Schema document 405 (e.g., an XSD schema document) is used to define a set of allowable attributes for a <FRUIT> element of data hierarchy 400. Specifically, schema document 405 includes elements for <TYPE>, <COLOR>, and <WEIGHT> for instances of the <FRUIT> element. And data hierarchy 405 includes five nodes representing instances of the <FRUIT> type (labeled 1-5). Each node may include an XML document storing the attributes of the <FRUIT> element expressly set by that node—listed in FIG. 4 as “source values.”

As shown in this example, at no point in the data hierarchy 400 (except for node 1) does any node have a complete set of elements of <FRUIT>, as defined by schema document 405. Implicitly however, it is possible to derive a complete fully populated <FRUIT> XML Document for node 3 and descendant nodes 4 and 5.

In this example, the root node (node 1) includes a source value 405 of “APPLE” for the <TYPE> element. This value may be inherited by each descendant; namely, nodes 2, 3, 4, and 5. For example, node 3 (a child of node 1) includes source values 415 setting the <COLOR> and <WEIGHT> attributes of this node to “RED” and “500,” respectively. However, node 3 does not include a source value for the <TYPE> element. Accordingly, a value of “APPLE” for this attribute may be inherited from the parent of node 3 (i.e., node 1). Similarly, node 4 (a child of both nodes 3 and 1) includes a source value 405 where no attributes are expressly set.

Accordingly, node 4 inherits the <COLOR> and <WEIGHT> attributes from node 3 and inherits the <TYPE> value from node 1. In contrast, node 5 includes a source value 425 setting the <WEIGHT> element. Thus, node 5 does not inherit this value from node 3. However, node 5 does inherit the <COLOR> value from node 3 and the <TYPE> value from node 1. This latter example illustrates that a value that would otherwise be inherited (e.g., the <WEIGHT> value of “500” from node 3) may be overridden by expressly setting a value within a given node. In other words, a node in the hierarchy only inherits data values not expressly set by that node. Of course, in one embodiment, the data inheritance tool 112 could be configured to override an expressly set value with an inherited one from a seed node (i.e., to force inheritance), as warranted by the needs of a particular case.

As shown, a virtual XML document 430 represents the fully derived version of node 5. Thus, document 430 includes the <WEIGHT> value set by source values 425 as well as the values for the <COLOR> and <TYPE> attributes inherited from nodes 3 and 1, respectively.

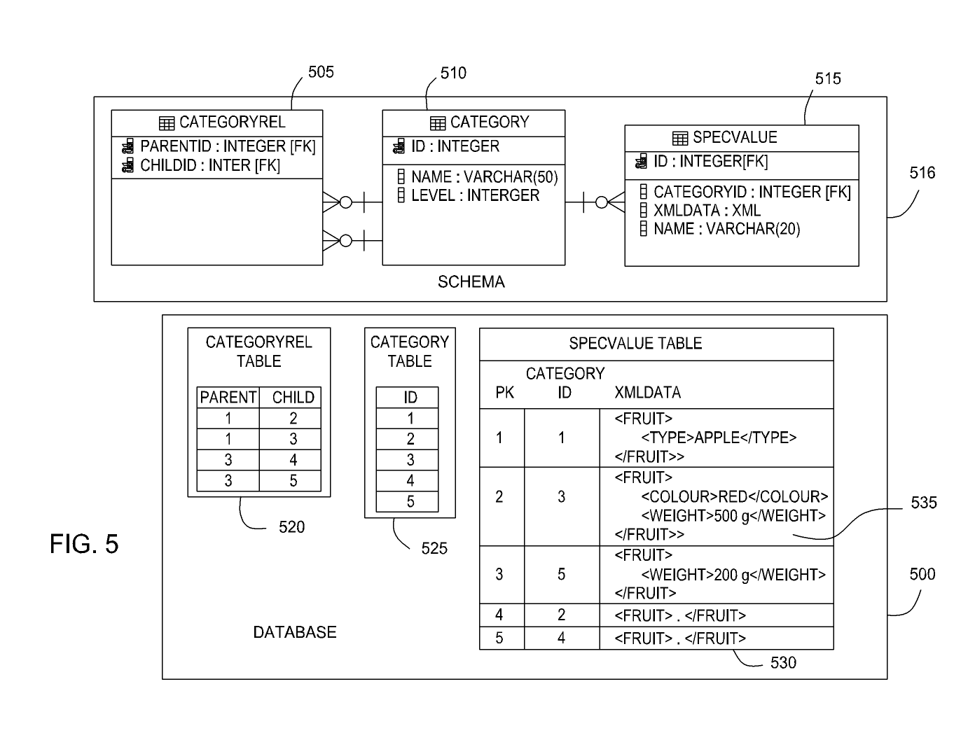

FIG. 5 illustrates an example of a relational database schema 516 and data tables 500 used to store a hierarchy of data stored in an XML document, according to one embodiment of the invention. Database schema 516 models the data hierarchy 400 of FIG. 4.

As shown, the schema 505 includes a definition 505 for a category relationship table 520. The definition 505 specifies that the category relationship table 505 includes a parent ID column and a child ID column (i.e., columns indicating the parent child relationships between nodes of the data hierarchy 405). Schema 516 also includes a definition 510 for a category table 525. The definition 510 specifies that the category table 525 includes an integer valued ID column (i.e., an ID value for a node of the data hierarchy 400).

Lastly, schema 116 includes a definition 515 for a specValue table 530. The definition 515 specifies that each record in the specValue table 530 includes an integer ID value, a reference to the category ID in the category table, and a column for XML data (i.e., a column for the XML document representing source values assigned by given node of the data hierarchy 400). That is, the specValue table 515 stores an ID value, the XML data (or data in any other format) for a node of the data hierarchy 400 along with a foreign key to the category table 510 (indicating the parent of that node).

Hence, any single XML document is explicitly linked to one and only one node in the data hierarchy 400. Further, each node (i.e., each XML document in the specValue table) is linked to the node's ancestors and descendants via the category relationship table 505. For example, the category relationship table 520 includes records indicating that node 1 is the parent of nodes 2 and 3 of the data hierarchy 400 and further, that node 3 is a parent of nodes 4 and 5 of the data hierarchy 400. Note, as shown in this example, only the data explicitly set by a node is stored in the database tables 500. Getting a complete picture of the data assigned to any node requires an upward traversal of the hierarchy, accumulating data until the root is reached. Illustratively, e.g., record 535 in the specValue table 530 corresponds to node 5 in data hierarchy 400. Accordingly, the XML data in record 535 includes the XML specified by source value 425 (i.e., a value for the <WEIGHT> element set by node 5 of data hierarchy 400. The data stored in the category relationship table 520 may be used to traverse upward from a node 5 to its parent. For example, from node 5 to node 3 and from there to the parent of the parent node (i.e., from node 3 to node 1), etc.

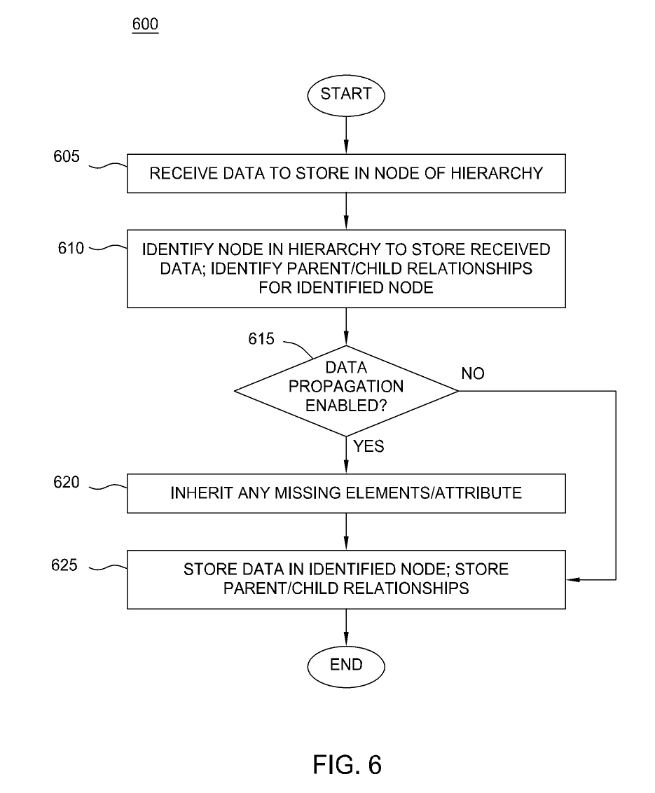

FIG. 6 illustrates a method 600 for storing data organized in a taxonomy or hierarchy in a database system, according to one embodiment of the invention. As shown, the method 600 begins at step 605 where data values to store in a node of the hierarchy are received. For example, the data inheritance tool may receive an XML document to store at a node in the hierarchy. Once received, the data inheritance tool may identify a node in the hierarchy to store the XML document received at step 605 as well as identify the parent child relationships for that node. The node may be an existing node in the hierarchy (in the case of an update to the XML document representing a given node) or to add a new leaf node to the hierarchy.

At step 615, if data propagation is enabled, then the data inheritance tool may identify the ancestors of the node identified at step 610. In particular, at step 620, the data inheritance tool may identify data values to actually inherit from ancestor nodes of the node identified at 610. As noted above, in one embodiment, the propagation may result in data values being copied from ancestor nodes to the node identified at step 610, or links to ancestor nodes being stored in the node identified at step 610. At step 625, the data values received at step 605 may be stored in the node identified at step 610 along with the parent child relationships between the node identified at step 610 and other nodes of the hierarchy. For example, an XML document may be stored in the record of a database table (along with an indication of an ID value for that node and ID value for a parent node). Further, in cases where data propagation is enabled, any missing elements or attributes inherited at step 620 may be added to the XML document.

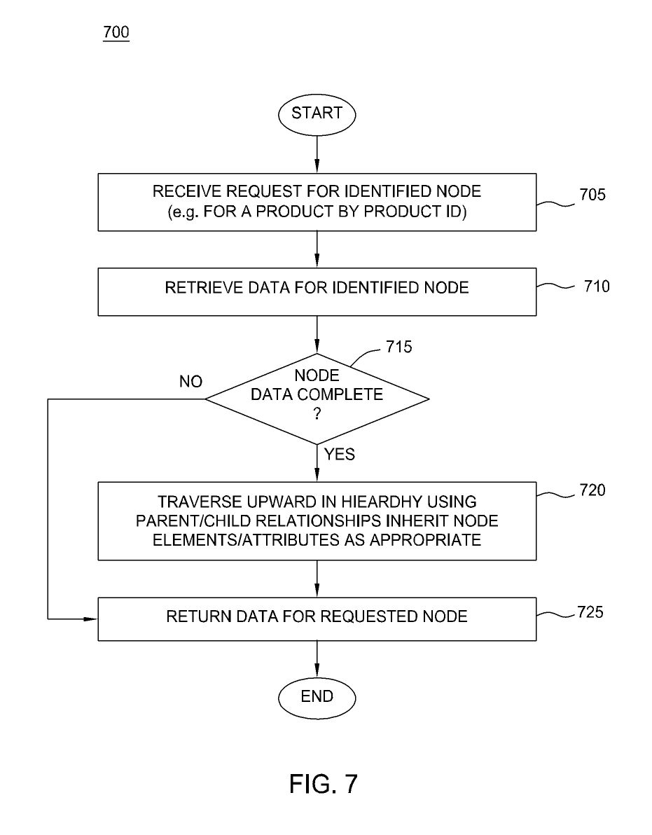

If data propagation is not enabled, then following the “NO” branch of step 615, the data received at step 605 (e.g., an XML document) is stored in the node of the hierarchy identified at step 610 along with the parent child relationships for that node, as needed. That is, only the information expressly set by the data received at step 605 is stored for this node. Of course, the node identified at step 610 may still implicitly inherit data values from ancestor nodes. And in such cases, the inherited values are identified when the actual data values are needed to generate a virtual XML document representing a complete profile of a given node in the hierarchy. For example, FIG. 7 illustrates a method 700 for inheriting values for a data record stored in a taxonomy or hierarchy in a database system, according to one embodiment of the invention.

As shown, the method 700 begins at step 705 where the data inheritance tool receives a request for an identified node in a data hierarchy. For example, assume a request is received to return all the XML data associated with node 5 of the data hierarchy illustrated in FIG. 4. At step 705, the data inheritance tool may retrieve data for the identified node. In one embodiment, e.g., the data inheritance tool may generate a query executed by a DBMS against a collection of tables.

Continuing with node 5 of FIG. 4, the data inheritance tool may execute a query to retrieve the XML data explicitly assigned by the source value document 425 of FIG. 4 (stored in the record 535 of the specValue table 530 of FIG. 5). In this particular example, an XML document which expressly sets the <WEIGHT> element of schema 405 to a value of two hundred. Note, in this example, the XML document stored in record 535 does not include values for the <COLOR> or <TYPE> elements of the <FRUIT> schema 405. Accordingly, at step 715, the data inheritance tool determines that the profile for the requested node is not complete. And at step 720, the data inheritance tool traverses upward in the hierarchy using the parent/child relationships stored in the database in order to inherit data values from ancestor nodes as appropriate, until a full profile for the requested node is available (or the root node of the hierarchy is reached).

Returning to the request for node 5 of the data hierarchy 400 depicted in FIGS. 4 and 5, the data inheritance tool first traverses to node 3, the parent of node 5. At this node, the <COLOR> and <WEIGHT> elements are defined. And the XML document retrieved for node 5 inherits the <COLOR> value of RED from this node, but not the <WEIGHT> value, as this latter value is already defined by node 5. As the profile is still not complete, the data inheritance tool traverses again upward in the hierarchy to node 1, where the <TYPE> value of APPLE is inherited by the XML document of node 5. At step 725, data for the requested node may be returned, e.g., to a query tool 135 of FIG. 1 which submitted the request for a particular node received at step 705. For example, after inheriting values from nodes 1 and 3, the profile for node 5 is complete, and the resulting XML document (e.g., virtual XML document 430 of FIG. 4) may be returned to the requesting user.

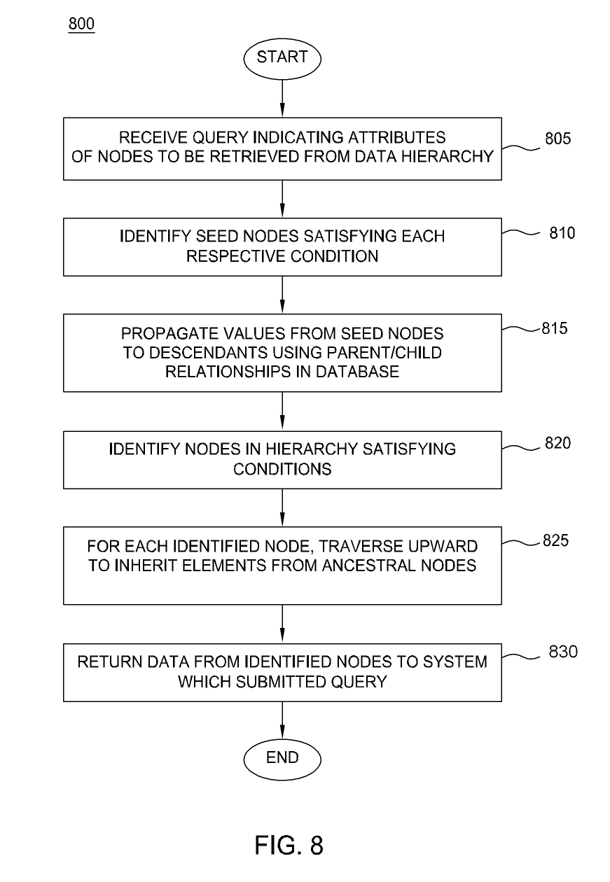

FIG. 8 illustrates a method 800 for retrieving data records stored in a taxonomy or hierarchy in a database system, according to one embodiment of the invention. As shown, the method 800 begins at step 805 where the data inheritance tool receives a query indicating attributes of nodes to retrieve form the data hierarchy. As an example, assume a query is received that requests each node of the <FRUIT> schema 405 with a value of RED for the <COLOR> attribute. At step 805, the data inheritance may evaluate nodes of the hierarchy having the attributes specified in the query. That is, the data inheritance tool may identify “seed” nodes with the requested attributes from which nodes descendant therefrom inherit such attributes. Again using the hierarchy of FIG. 4 as an example, the data inheritance tool would identify node 3 as a “seed” node, i.e., a node having RED as the value for the <COLOR> attribute. At step 815, the data inheritance tool propagates the value from the seed nodes identified at step 810 to any descendant nodes. For example, the value of “RED” would be propagated from node 3 to nodes 4 and 5 of the data hierarchy 400 of FIG. 4. Note, however, some of the descendent nodes may expressly set the same attribute of the seed value, e.g., the <WEIGHT> attribute of 500 set by node 3 would be propagated to node 4, but not to node 5, as the latter expressly sets a value of 200 for the <WEIGHT> attribute.

At step 820 after any values have been propagated from the seed nodes, the data inheritance tool may identify nodes in the hierarchy satisfying conditions of the query. Thus, at step 820, data inheritance tool could identify nodes 3, 4, and 5 as satisfying a query for all nodes of the data hierarchy 400 having a value of RED for the <COLOR> attribute. At step 825, the data inheritance tool may traverse upward to inherit elements not assigned explicitly to a given node. That is, once a set of nodes are identified that satisfy the query conditions (e.g., nodes assigned a RED value for the <COLOR> attribute), each such node may inherit other values from the data hierarchy (e.g., node 4 would inherit values for the <WEIGHT> and <TYPE>attributes and nodes 3 and 5 would inherit a value for the <TYPE> attribute.

At step 830, the identified nodes, along with any inherited values, may be returned, e.g., to a query tool 135 of FIG. 1. Thus, after inheriting values from nodes 1 and 3, the profiles of nodes 3, 4, and 5 are complete (which each have a value of RED for the <COLOR> attribute), and the resulting XML documents may be returned to the requesting user.

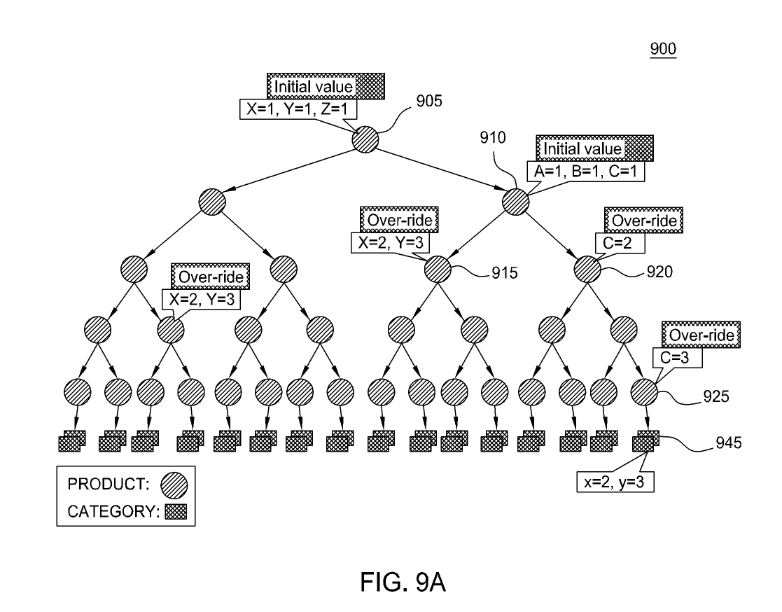

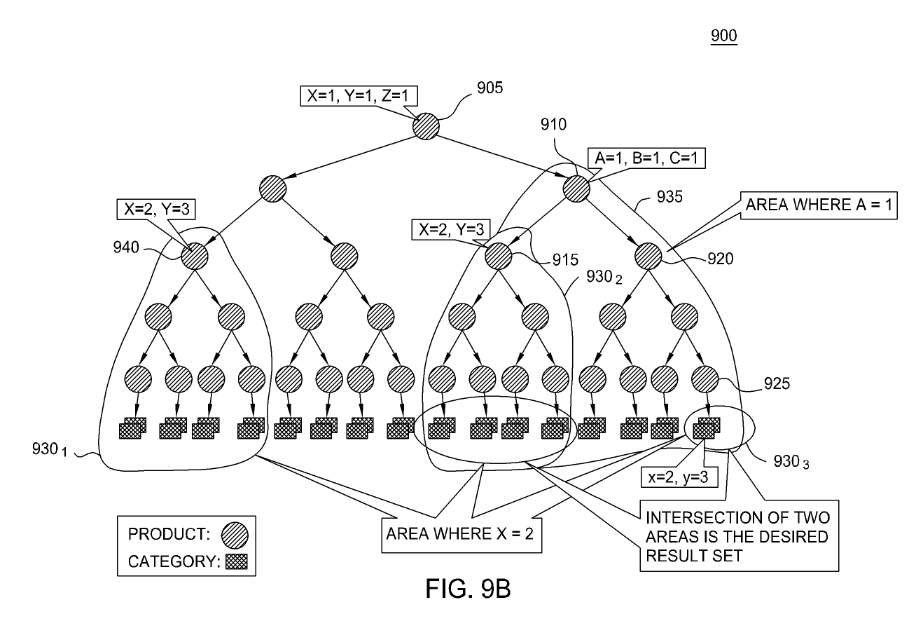

FIGS. 9A-9B provide an example of a hierarchy used to further illustrate the method shown in FIG. 8, according to one embodiment of the invention. As shown, a data hierarchy 900 is used to represent a collection of product categories (represented by nodes as a circle) and products (represented by nodes as a square). Additionally, values for attributes labeled A, B, C, X, Y, and Z may be assigned at any of the product or category nodes. For example, a root node 905 sets a value for the X, Y, and Z attributes of hierarchy 900 and node 910 sets a value for the A, B, and C attributes. Additionally, some nodes of the data hierarchy override the inherited values. For example, node 915 overrides the values for the X and Y attributes assigned by the node 905. Thus, while node 910 (and nodes descending from node 915 over the left branch) inherits a value for X, Y, and Z from node 905, node 915 does not. Further, the nodes descending from node 915 may inherit a value for X and Y from node 915, while still inheriting a value for Z from node 905. Similarly, node 915 inherits a value for A, B, and C, from node 910, while node 920 overrides the C attribute. Thus, nodes descending from node 920 inherit a value of C from node 920, a value for A and B from node 910, and a value for X, Y, and Z from node 905. However, the value for the C attribute is again overridden by node 925. Also, product node 945 overrides a value for the X and Y attributes, which would otherwise be inherited from node 905.

FIG. 9B illustrates an example query against the data hierarchy 900. In Specifically, a query stated as “Find all categorized items where A=1 AND X=2.” To evaluate this example query, the data inheritance tool identifies node 910 as a seed node for the “A=1” condition. Propagating this value down from the seed node results in a region 935 of the hierarchy where A=1. Additionally, category nodes 915 and 940 represent seed nodes for the “X=2” condition, and product node 945 assigns a value of “X=2” directly. Propagating the “X=2” value from nodes 915 and 940 results in the regions 930₁, 930₂, and 930₃ where “X=2.” By intersecting the product nodes in regions 930₁₋₃ and 935, product nodes having inherited (or assigned) values of “A=1” and “X=2” may be identified. Further, once the set of products satisfying the conditions of the query are identified, such nodes may inherit other values from their ancestors. For example, product node 945 may inherit values for the B and C attributes from node 910. Once a complete profile is derived for each product node identified in the intersection of the regions 930₁₋₃ and 935, the data for these nodes may be returned in response to the example query.

Advantageously, embodiments described herein provide techniques for storing, propagating, and searching for data stored in markup language documents, such as a data hierarchy defined by an XML schema. Each node in the data hierarchy may include an XML document representing an instance of the thing being categorized at that level of the hierarchy. A collection of such documents may be stored in a relational database according to a schema for storing the XML documents as well as the parent child relationships between the documents. Further, a document at one node in the hierarchy may inherit attributes from its ancestors. More specifically, embodiments of the invention provide techniques for one node within a given hierarchy to inherit data in from other nodes stored in the hierarchy as well as techniques for one node to propagate information from that node to descendants.

While the foregoing is directed to embodiments of the present invention, other and further embodiments of the invention may be devised without departing from the basic scope thereof, and the scope thereof is determined by the claims that follow.

What is claimed is:

1. A computer-implemented method for managing data stored in a hierarchy having a plurality of nodes, the method comprising:
configuring one or more computer processors to perform an operation, comprising:
identifying a first node of the hierarchy, wherein each node of the hierarchy of nodes is configured to store values for a set of one or more attributes,
identifying, for the first node, one of the attributes for which a value is not stored by the first node,
traversing, from the first node, to an ancestor node of the first node, wherein the ancestor node stores a value for the first attribute not stored by the first node, and
inheriting, by the first node, the value for the first attribute stored by the ancestor node.

2. The computer-implemented method of claim 1, further comprising, propagating, from the ancestor node, the value for at least the first attribute to one or more descendant nodes.

3. The computer-implemented method of claim 1, wherein each node stores the set of one or more attributes according to a markup language schema.

4. The computer-implemented method of claim 3, wherein the schema is an XML schema.

5. The computer-implemented method of claim 1, wherein inheriting, by the first node, the value for the first attribute stored by the ancestor node comprises storing a reference to the ancestor node in the first node.

6. The computer-implemented method of claim 1, wherein inheriting, by the first node, the value for the first attribute stored by the ancestor node comprises storing a copy of the value for the first attribute stored by the ancestor node in the first node.

7. The computer-implemented method of claim 1, further comprising:
receiving a query identifying a specified value for at least a second attribute of the set of one or more attributes;
identifying the first node as having the specified value for the second attribute.

8. The computer-implemented method of claim 1, wherein the plurality of nodes are stored as records in a relational database and wherein the relational database stores an indication of each parent node and each child node for each of the plurality of nodes, respectively.

9. A computer-readable storage medium containing a program which, when executed by a processor, performs an operation for managing data stored in a hierarchy having a plurality of nodes, the operation comprising:
identifying a first node of the hierarchy, wherein each node of the hierarchy of nodes is configured to store values for a set of one or more attributes;
identifying, for the first node, one of the attributes for which a value is not stored by the first node;
traversing, from the first node, to an ancestor node of the first node, wherein the ancestor node stores a value for the first attribute not stored by the first node; and
inheriting, by the first node, the value for the first attribute stored by the ancestor node.

10. The computer-readable storage medium of claim 9, further comprising, propagating, from the ancestor node, the value for at least the first attribute to one or more descendant nodes.

11. The computer-readable storage medium of claim 9, wherein each node stores the set of one or more attributes according to a markup language schema.

12. The computer-readable storage medium of claim 11, wherein the schema is an XML schema.

13. The computer-readable storage medium of claim 9, wherein inheriting, by the first node, the value for the first attribute stored by the ancestor node comprises storing a reference to the ancestor node in the first node.

14. The computer-readable storage medium of claim 9, wherein inheriting, by the first node, the value for the first attribute stored by the ancestor node comprises storing a copy of the value for the first attribute stored by the ancestor node in the first node.

15. The computer-readable storage medium of claim 9, wherein the operation further comprises:
receiving a query identifying a specified value for at least a second attribute of the set of one or more attributes;
identifying the first node as having the specified value for the second attribute.

16. The computer readable storage medium of claim 9, wherein the plurality of nodes are stored as records in a relational database and wherein the relational database stores an indication of each parent node and each child node for each of the plurality of nodes, respectively.

17. A system, comprising:
one or more computer processors; and
a memory containing a program, which when executed by the one or more computer processors is configured to perform an operation for managing data stored in a hierarchy having a plurality of nodes, the operation comprising:
identifying a first node of the hierarchy, wherein each node of the hierarchy of nodes is configured to store values for a set of one or more attributes,
identifying, for the first node, one of the attributes for which a value is not stored by the first node,
traversing, from the first node, to an ancestor node of the first node, wherein the ancestor node stores a value for the first attribute not stored by the first node, and
inheriting, by the first node, the value for the first attribute stored by the ancestor node.

18. The system of claim 17, further comprising, propagating, from the ancestor node, the value for at least the first attribute to one or more descendant nodes.

19. The system medium of claim 17, wherein each node stores the set of one or more attributes according to a markup language schema.

20. The system of claim 19, wherein the schema is an XML schema.

21. The system of claim 17, wherein inheriting, by the first node, the value for the first attribute stored by the ancestor node comprises storing a reference to the ancestor node in the first node.

22. The system of claim 17, wherein inheriting, by the first node, the value for the first attribute stored by the ancestor node comprises storing a copy of the value for the first attribute stored by the ancestor node in the first node.

23. The system of claim 17, wherein the operation further comprises:
receiving a query identifying a specified value for at least a second attribute of the set of one or more attributes;
identifying the first node as having the specified value for the second attribute.

24. The system of claim 17, wherein the plurality of nodes are stored as records in a relational database and wherein the relational database stores an indication of each parent node and each child node for each of the plurality of nodes, respectively.

25. A computer-implemented method for managing data stored in a hierarchy having a plurality of nodes, the method comprising:
configuring one or more computer processors to perform an operation, comprising:
identifying a first node of the hierarchy, wherein each node of the hierarchy of nodes is configured to store values for a set of one or more attributes, and wherein the first node stores a value for at least a first attribute of the set of one or more attributes; and
propagating, from the first node, the value for at least the first attribute to one or more descendant nodes.
